(19) United States
(12) Patent Application Publication
(10) Pub. No.: US 2012/0074803 A1
(43) Pub. Date: Mar. 29, 2012

(54) Electric generator

(76) Inventor: Wendell Ray Walker, Dixon Springs, TN (US)

(21) Appl. No.: 13/065,277

(22) Filed: Mar. 16, 2011

Related U.S. Application Data
(60) Provisional application No. 61/340,345, filed on Mar. 16, 2010.

(51) Int. Cl. H02K 1/28; H02K 7/08; H02K 7/09

(52) U.S. Cl. 310/90.5; 310/156.08; 310/90

(57) ABSTRACT

My Improved Electrical Generator is a high efficiency generator that functions by a series of frictionless bearings and rotating magnets.

This application is a continuation of my Provisional Patent Ser. No. 61/340,345, filed Mar. 16, 2010

### BACKGROUND OF INVENTION AND BRIEF SUMMARY

This invention relates generally to electrical generators and more specifically to electric generators that convert mechanical energy into electric current by rotating either magnets or copper wire coils on a central shaft or “rotor” inside a closed container with either copper wire coils or magnets fixed to its inside walls thus by the spinning of the rotor's action and the varying of the magnets poles induces electrical current in the copper coils.

Throughout the history of the electric generator there has existed the problem that when you put what is generally known as “load” such as, an electric light into the electric circuit it becomes harder to turn in proportion to the amount of electric current being used to light lights, run heaters, etc. and therefore, requiring much more mechanical energy to keep the rotor spinning. This is a result of Lenz's Law that states: when a conductor cuts magnetic lines of induction, the induced current in the wire is in such a direction that its own magnetic field generated by that current acts on the original magnetic field in a way opposing the motion which produced it; formulated by the Russian H. F. Lenz in 1833.

The electric generator was not invented. The explanation of this is that it is actually the very first electrical device ever patented in the United States which was Thomas Davenport's electric motor on Feb. 25, 1837. He had vast visions of electric trains, washing machines, etc., none of which he ever saw in his life time because the only source of electric current were batteries. It was years later, after his death, that someone unknown discovered that by turning his electric motor with mechanical energy it was converted into electric current. Put more simply, the electric motor and this type of electric generator are the same machine.

Thus, it can truly be said that the electric generator was not put through the invention process or scientific observations therefore, causing its odd position in electrical science that some of the beliefs that surround it are actually just that and not genuine laws of physics.

In accordance with the foregoing, it may be regarded as an object of the present invention to provide an electrical generator that is so configured as to overcome the effects of Lenz's Law thus providing a much more efficient electrical generator in its corresponding saving of fuel cost.

Now, in accordance with the present invention the foregoing, and other, will become apparent in the course of the ensuing specification and are achieve by providing an electrical generator whose rotor which has fixed to its central shaft two parallel cross members (wings that function in the low pressure internal atmosphere of the generator and negate the usual up and down motion of the opposing magnets) that have at their outer ends bearings with an axel connected between them and on these axels are mounted circular magnets, in the generators closed container copper coils are mounted on inside walls of the closed container in a position that as the rotor spins the magnets passing by induce electrical current in the coils and its opposing magnetic field exerts its force against the magnet. The magnet itself is caused to turn and therefore “rolls” past the copper coil relieving the affects of Lenz's Law.

The next point of friction is caused by the centrifugal force, caused by the spinning rotor, acting on the spinning magnet to throw them outwards, this is overcome by solid aluminum bearings imbedded in the wings to oppose magnets on the axils that are magnetized (+) plus and (−) negative side to side therefore inducing electric current in the aluminum as they spin with the axils and the resulting magnetic field that opposes them makes it impossible for them to actually touch the bearings.

Now, in accordance with the present invention, the foregoing objects and others, as will become apparent in the course of ensuing specification, are achieved in this improved electrical generator.

### BRIEF DESCRIPTION OF THE SEVERAL VIEWS OF THE DRAWING

FIG. 1 is the front view of the improved electrical generator.

FIG. 2 is the right side view of the improved electrical generator.

FIG. 3 is the left side view of the improved electrical generator.

FIG. 4 is the interior view of the improved electrical generator

FIG. 5 is the top view of the wing having a cut away view of the aluminum frictionless bearing with magnet.

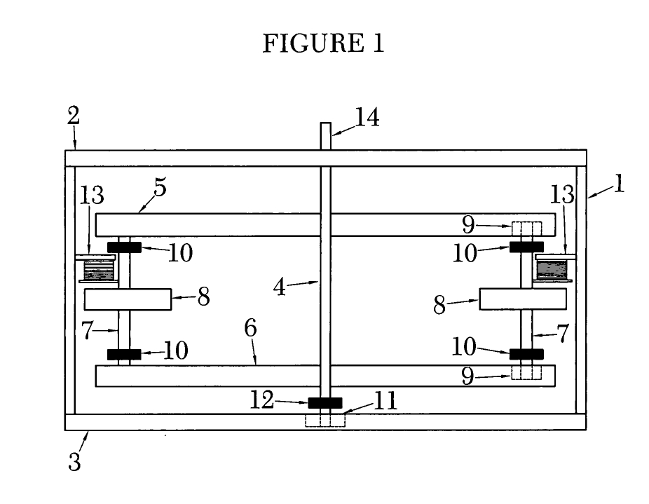

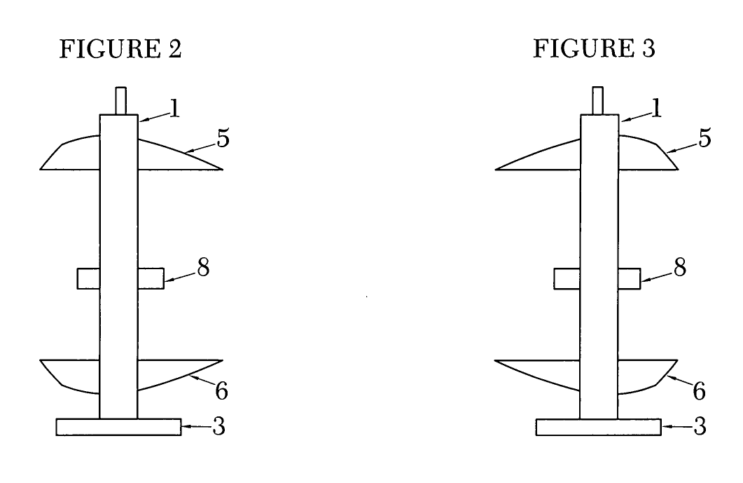

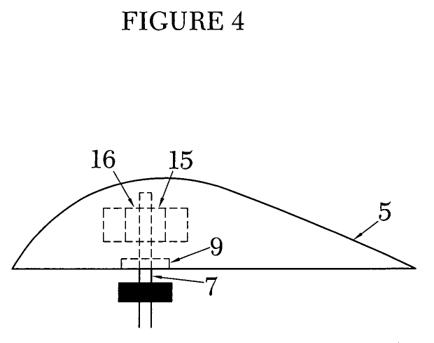

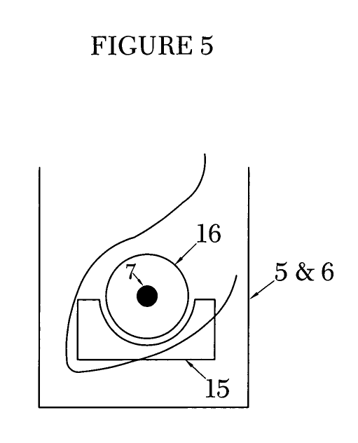

1. “An electrical generator comprising: of circular magnets, instead of fixed magnets, that pass by the coils, and the “drag”, common to all conventional generators, is overcome as the circular magnets rotate on their shafts.”

2. “A frictionless bearing comprising of opposing magnets that are compressed and float on opposing fields so that the friction caused by gravity is negated.

3. “A stabilized levitation comprised of: that which is produced by the two wings on the center shaft that operate in a low pressure internal atmosphere that negates the usual up and down motion of opposing magnetic fields.”

4. “A frictionless bearing that negates the effect centrifugal force that would Throw the rotating magnets in the wing outward
